(19) United States
(12) Patent Application Publication
(10) Pub. No.: US 2017/0326466 A1
(43) Pub. Date: Nov. 16, 2017

(54) MOBILE TOYS USING PAPER CRAFT

(71) Applicant: 3.14 CO., LTD., Daegu (KR)

(72) Inventor: Deok Byeong CHAE, Busan (KR)

(73) Assignee: 3.14 CO., LTD., Daegu (KR)

(21) Appl. No.: 15/527,007

(22) PCT Filed: Sep. 12, 2016
(86) PCT No.: PCT/KR2016/010266

§ 371 Date: May 15, 2017

(30) Foreign Application Priority Data
Sep. 14, 2015 (KR) 10-2015-0129380
Sep. 21, 2015 (KR) 10-2015-0132783

(51) Int. Cl. A63H 17/00; H04R 1/02; G06K 7/14; A63H 5/00; A63H 33/16; A63H 30/04; A63H 17/28; G06K 7/10; H04W 4/00

(52) U.S. Cl. CPC A63H 17/002; G06K 7/10297; H04R 1/028; G06K 7/1413; G06K 7/10722; A63H 5/00; A63H 33/16; A63H 30/04; A63H 17/28; H04W 4/008

(57) ABSTRACT

Disclosed are mobile toys using paper craft which can be widely applied in various ways, as well as being friendly and attracting interest by operating a paper model. The mobile toy using paper craft includes a drive device including at least one operating unit which is operated by a power, and a paper model including a plurality of model units which are made on the basis of a development figure and are assembled and engaged to an outside of the drive device to form a toy, at least one of the mobile units being detachably engaged to the operating unit.

### TECHNICAL FIELD

The present invention relates to mobile toys using paper craft, and, more particularly, to mobile toys using paper craft which can be widely applied in various ways, as well as being friendly and attracting interest by operating a paper model.

### BACKGROUND ART

Paper toys or paper craft using paper models which are made based on a development figure drawn on paper are widely used for the purpose of play or education for children or teenagers.

Examples of the paper toys or paper craft are disclosed in Korean Patent No. 10-1254458 (entitled “Paper Model Toy” and hereinafter referred to as Related Art 1) and Korean Utility Model No. 20-441071 (entitled “DIY Fabricated Kit of Insect Model” and hereinafter referred to as Related Art 2).

Related Art 1 discloses a paper model toy capable of easily making a toy of three-dimensional model by folding and bonding paper of the respective components.

Related Art 2 discloses the configuration of an insect model having a light emitting part which can be switched on and off, and the insect model can be driven by an eccentric motor.

The above related arts are limited to the simple application of the paper toys or paper craft, and are not deviated from the scope of the existing paper craft which assembles the paper based on the development figure. Therefore, it is difficult to arouse a user's interest after the process of making the paper toy (after the paper toy is assembled).

Also, since there is no development figure having various levels of difficulties in view of a level of a user, kidult who is interested in the paper craft cannot be recently provided with proper paper toys.

Therefore, it is required to develop a device and appliance capable of arousing continuous interest and possessing desire, as well as playing with the paper toy or paper craft or developing creativity, instead of bulk and heavy books.

### DISCLOSURE

### Technical Problem

Accordingly, the present invention has been made in view of the above-mentioned problems occurring in the related arts, and an object of the present invention is to provide a fabricated mobile toy using paper craft which can be friendly and attract user's interest by operating a paper model, which can assist in development of creativity and play by applying various levels of difficulties and designs in view of a level of a user, and which can arouse a possessing desire.

The object of the present invention is not limited to the above-described one, and other objects can be clearly understood from the following description.

### Technical Solution

To accomplish the above-mentioned object, there is provided a mobile toy using paper craft including a drive device including at least one operating unit which is operated by a power, and a paper model including a plurality of model units which are made on the basis of a development figure and are assembled and engaged to an outside of the drive device to form a toy, at least one of the mobile units being detachably engaged to the operating unit.

Preferably, the drive device includes a loudspeaker unit to output desired sound, an illumination unit to emit a desired pattern of light, and a reader unit to scan a predetermined object to be identified on one side thereof.

Preferably, one of the model units is provided on one side thereof with an identification portion which is scanned by the reader unit.

Preferably, the operating unit of the drive device is provided with a magnet having a desired magnetic force, and the model unit engaged to the operating unit is provided with a magnetic body which is adhered to the magnet.

Preferably, the reader unit includes a non-contact near field communication reader or a barcode scanning camera, and the identification portion includes an electronic tag or barcode which is scanned by the reader unit.

Preferably, the drive device includes a board on which electronic devices are mounted to drive and control the operating unit, and a body formed in the shape of a case to house the board therein, and formed with a communication hole through which the operating unit comes into surface-contact with the model unit.

Preferably, the board is provided with a communication module which is electrically connected to the operating unit, so as to communicate with a smartphone via near field communication, and the operating unit is controlled by remote control application installed in the smartphone.

Preferably, the operating unit is operated in any one manner among rotation movement, vertical movement, horizontal movement, tilting movement, and piston movement through combination of a plurality of driving members, and the operating unit is controlled by selecting one of the operation manners by the remote control application installed in the smartphone.

Preferably, one of the plurality of model units is a body model unit which is brought into surface-contact with a body of the drive device, and is provided with on an inner surface thereof with an identification portion, and the identification portion is disposed at a position corresponding to the reader unit when the body model unit is engaged to the body, and is scanned by the reader unit.

Preferably, the identification portion contains identification information corresponding to a kind of the paper model, and at least any one of the loudspeaker unit, the illumination unit, and the operating unit is driven by predetermined algorithm according to the identification information scanned by the reader unit.

Preferably, the board is provided with a communication module which is electrically connected to the loudspeaker unit, the illumination unit, the operating unit, and the reader unit, so as to communicate with a smartphone via near field communication, and at least one of the loudspeaker unit, the illumination unit, and the operating unit is controlled by the remote control application installed in the smartphone.

### Advantageous Effects

With the above configuration, the mobile toy according to the present invention has the following advantages.

The paper model can be made on the basis of the development figure having various levels of difficulty and various designs, and can be operated in cooperation with the drive device in various manners according to the kinds of the paper models. Therefore, since the paper model is friendly and animatedly realized, the paper model can arouse continuous interest and possessing desire.

Instead of bulk and heavy books or toys, users can directly make a paper model corresponding to education or play on the basis of the development figure, and the paper model can be connected with the education or the play in cooperation with the drive device, thereby developing the creativity.

Since the paper models of various designs can be easily attached to or detached from the operating unit of the drive device by the magnet and the magnetic body, the paper model can be immediately replaced by a paper model of a different design depending upon the situations. Therefore, people of all ages can handle the paper model, and it can continuously arouse user's interest in the mobile toy at education or play.

Finally, since modules having several functions are mounted on the drive device and are operated in various manners in cooperation with the smartphone, the present invention can be extended to products of various kinds.

### DESCRIPTION OF DRAWINGS

FIG. 1 is a view illustrating an example of a development figure which forms the basis of making a paper model according to the present invention.

FIG. 2 is a perspective view illustrating a paper model according to one embodiment of the present invention.

FIG. 3 is a perspective view illustrating a drive device according to one embodiment of the present invention.

FIG. 4 is an exploded perspective view illustrating a state before the paper model and the drive device according to the present invention are assembled.

FIGS. 5 and 6 are views illustrating examples of a reader unit according to the present invention which scans an identification portion.

FIGS. 7 to 10 views illustrating examples of an operating unit which can be applied to the drive device of the present invention.

FIG. 11 is a perspective view illustrating a state after the paper model and the drive device according to the present invention are assembled.

FIG. 12 is a perspective view illustrating a state in which the paper model is detached from the drive device in FIG. 11, and other paper model is assembled to the drive device.

### MODE FOR INVENTION

The above and other advantages and features of the present invention and a method for achieving those will be clearly understood with reference to the embodiments described in detail with the accompanying drawings. The accompanying drawings are used to help easily understand the technical idea of the present invention, and it should be understood that the idea of the present invention is not limited by the accompanying drawings. The terminology used herein is for the purpose of describing particular embodiments only and is not intended limit the right scope of the present invention. As used herein, the singular forms “a”, “an” and “the” are intended to include the plural forms as well, unless the context clearly indicates otherwise.

Hereinafter, preferred embodiments of the present invention will be described in detail with reference to the accompanying drawings. In the following description, detailed descriptions of well-known functions or constructions will be omitted since they would obscure the invention in unnecessary detail.

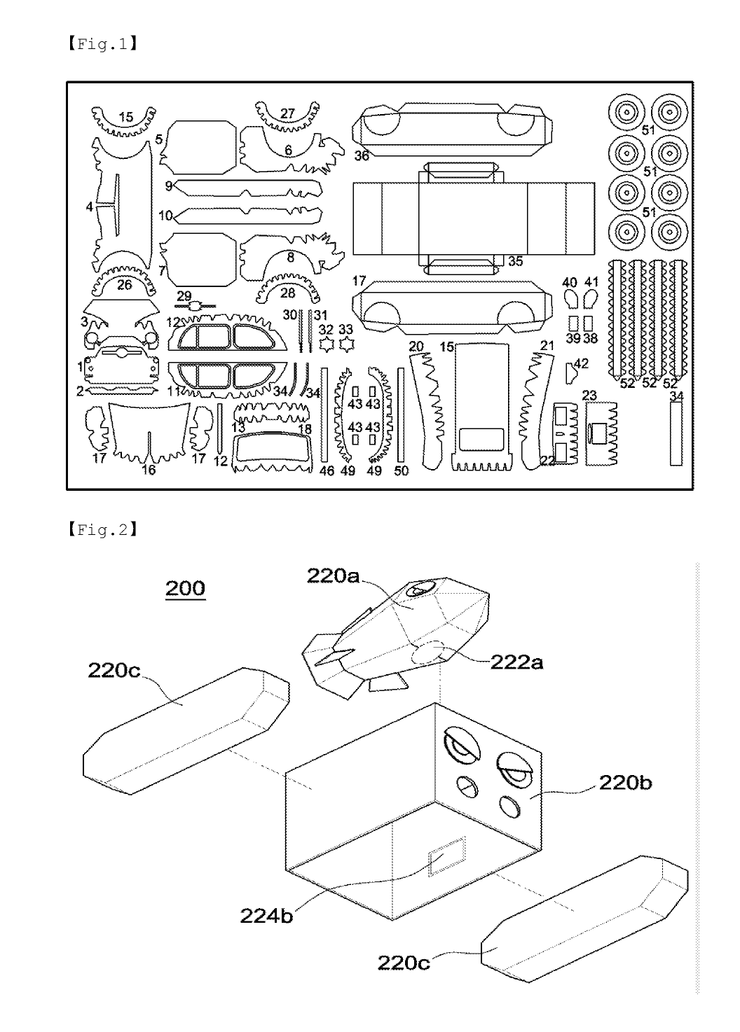

A mobile toy using paper craft according to an embodiment of the present invention generally includes a paper model 200 and a drive device 400, and will be described in detail with reference to FIGS. 1 to 12. The drive device will be described after the paper model 200 is described, for descriptive convenience.

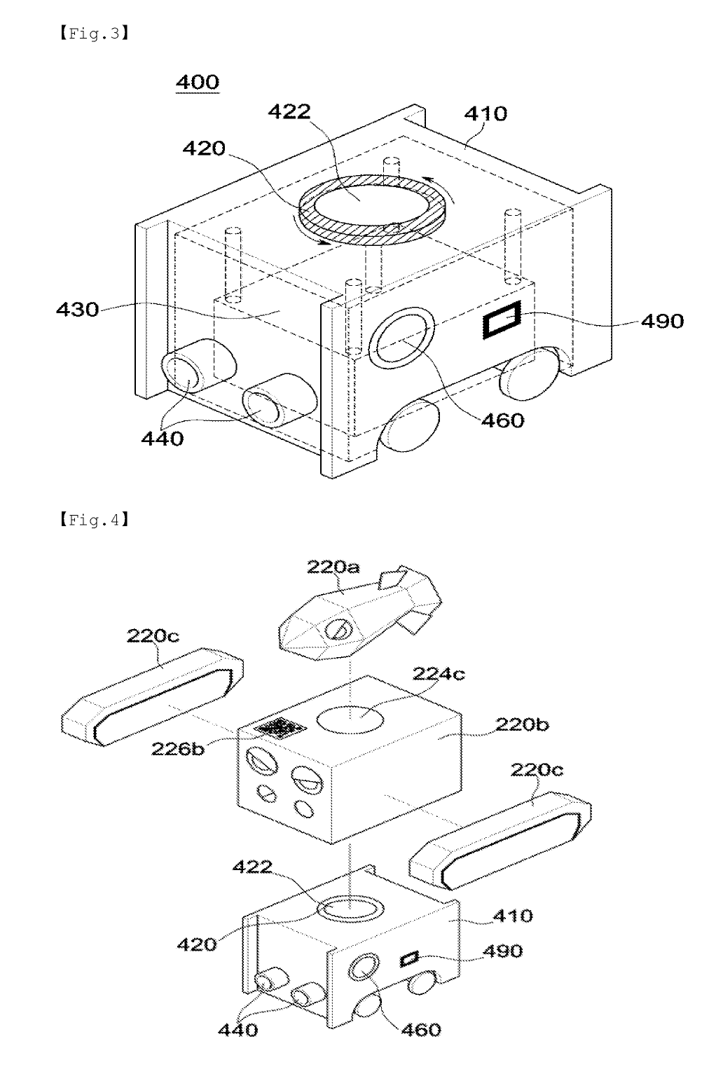

The paper model 200 includes a plurality of model units of desired three-dimensional shapes which are formed by cutting, folding and bonding paper based on a development figure, as illustrated in FIG. 1, and is assembled and engaged to the outside of the drive device which will be described later. Specifically, the paper model 200 includes a plurality of model units 220a, 220b and 220c, as illustrated in FIG. 2. The development figure in FIG. 1 and the model units 220a, 220b and 220c in FIG. 2 are not associated with each other, but are merely examples.

At least one of the model units 220a, 220b and 220c can be detachably engaged to an operating unit 420 of the drive device 400 which will be described later, so as to be moved animatedly.

The model unit 220a engaged to the operating unit 420 may be provided with a magnetic body 222a. The operating unit 420 is provided with a magnet 422, and thus the model unit 220a can be easily attached to or detached from the operating unit 420. The magnet body 222a is provided at a portion in which the model unit 220a is brought into surface-contact with the operating unit 420, thereby obtaining firm magnetic attraction between the model unit 220a and the operating unit 420.

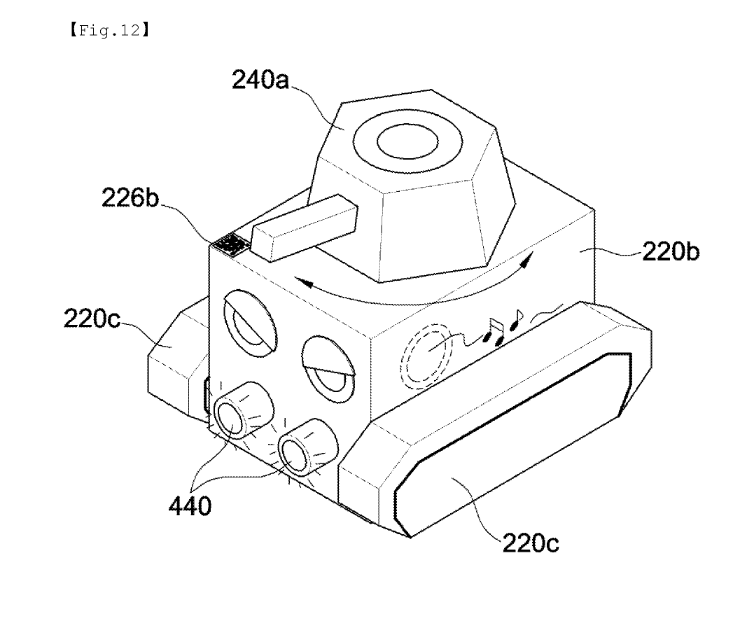

The model unit 220a engaged to the operating unit 420 can be directly attached to or detached from the operating unit 420, but the present invention is not limited thereto. It would be understood that the model unit can be attached to or detached from other model unit which encloses the operating unit 420, by means of a magnetic force. For example, as illustrated in FIG. 11, a head model unit 220a can be attached to a body model unit 220b enclosing the drive device 400.

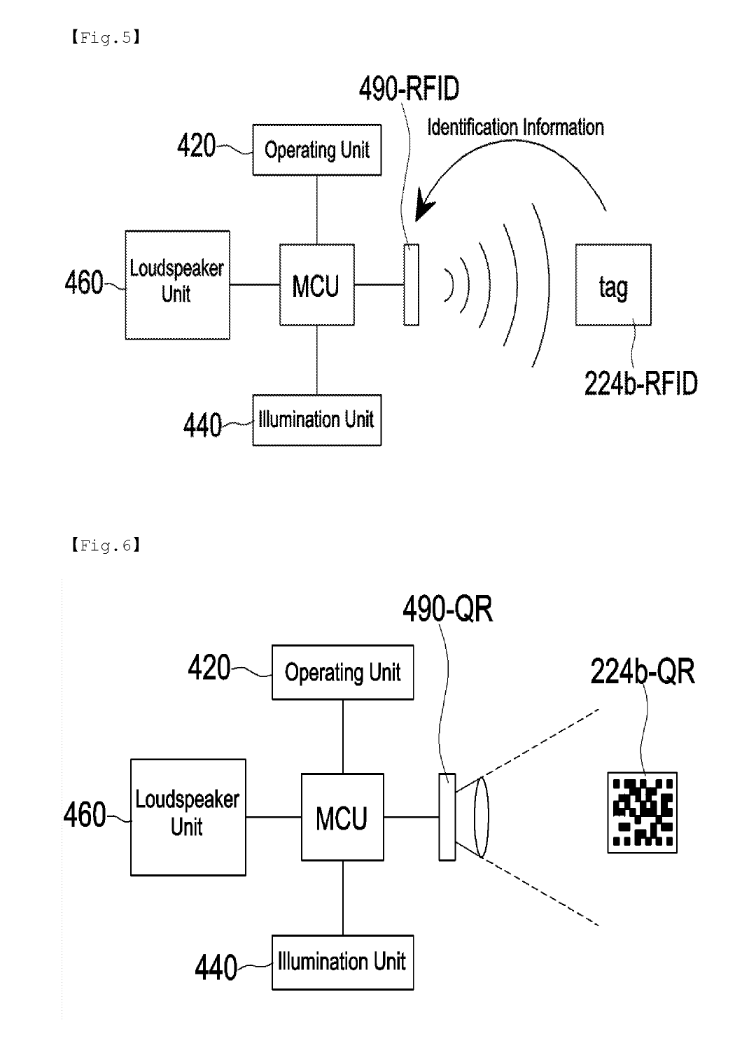

In addition, as illustrated in FIG. 4, the body model unit 220b is preferably provided with a guide line 224c. The guide line 224c serves to accurately guide an attaching position of the head model unit 220a which is attached to the operating unit 420 when the body model unit 220b encloses the operating unit 420.

At least one of the model units 220a, 220b and 220c is provided on one side thereof with an identification portion 224b which is scanned by a reader unit 490 of the drive device 400, as illustrated in FIG. 2. The identification portion 224b will be described in detail later with conjunction with the drive device 400.

The drive device 400 includes, as illustrated in FIG. 3, a loudspeaker unit 460 to output desired sound, an illumination unit 440 to emit a desired pattern of light, and at least one operating unit 420 which is driven by a power. The loudspeaker unit 460, the illumination unit 440, and the operating unit 420 are driven in cooperation with the above-described paper model 200, so that the paper model 200 assembled and engaged to the drive device 400 can be realized animatedly.

It would be understood from FIG. 3 that the operating unit 420 is provided with the magnet 422 having a desired magnetic force. The magnet 422 is preferably provided on a top surface of the operating unit 420 so that the model unit 220a having the magnetic body 222a is easily attached to or detached from the operating unit. Since the operating unit 420 with the magnet 422 does not have separate engaging means or engaging structure to which the model unit 220a is attached, the construction is very simple, and the attachment or detachment can be easily performed. In addition, since it is not impossible to attach or detach the mobile unit due to the damage to the engaging means or engaging structure, the durability thereof is supposed to be enhanced.

The drive device 400 is provided with the reader unit 490 to scan the predetermined object to be identified. The reader unit 490 scans the identification portion 224b of the paper model 200 to obtain identification information about a kind or shape of the paper model 200.

Specifically, it would be understood from FIGS. 2 to 4 that any one of the plurality of model units is the body model unit 220b which is brought into surface-contact with the body 410 of the drive device 400, thereby forming the identification portion 224b on the inner surface thereof. The identification portion 224b is disposed at a position corresponding to the reader unit 490 when the body model unit 220b is engaged to the body 410, and thus is scanned by the reader unit 490.

The reader unit 490 may include a near field communication reader 490-RFID, as illustrated in FIG. 5. In this instance, the identification portion is preferably an electronic tag 224b-RFID which can be scanned by the reader 490-RFID. It is substantially similar to radio frequency identification (RFID) that identifies an ID using a frequency, wherein the reader 490-RFID reads the identification information of the paper model, which is stored in the identification portion made of a microchip, to send it to a control module.

The control module controls the loudspeaker unit 460, the illumination unit 440, and the operating unit 420 on the basis of the received identification information. The loudspeaker unit 460, the illumination unit 440, and the operating unit 420 are differently operated according to the kind of the paper model 200 which is assembled and engaged to the drive device, thereby continuously arousing user's interest in the mobile toy.

The control module may include a dedicated processor to control a specific system, like a micro controller unit (MCU), and software capable of executing a function of a specific purpose according to the kind of the drive device 400 in order to show various functions. In this instance, the software includes a drive algorithm to control the loudspeaker unit 460, the illumination unit 440, and the operating unit 420 in a predetermined way.

In addition, the reader unit 490 and the identification unit 224b may be realized by the NFC system which is a concept extended from the RFID system. The NFC is a technology of sending data within a near distance of about 10 cm by use of a near field communication module using a frequency band of 13.56 MHz.

The NFC can be operated in an active mode built with a tag, so that the NFC can serve as functions of a reader to read the tag and a writer to input information in the tag, as well as a function of the tag.

As illustrated in FIG. 5, the reader unit may include a barcode scanning camera 490-QR. In this instance, the identification portion is preferably a barcode 224b-QR which can be scanned by the camera.

The barcode 224b-QR can be permanently printed on the inner surface of the body model unit 220b, and may include a linear barcode to represent information by varying width and spacing of parallel lines, and a 2D barcode containing black squares arranged in a square grid to represent information. The 2D barcode includes a QR code, a data matrix, a PDF417, and a Maxi Code. Preferably, the present invention employs the QR code and the data matrix so as to be easily activated under camera recognition circumstance of smart devices.

That is, the identification portion consisting of the barcode 224b-QR contains the information about the kind of the paper model 200, and after the camera 490-QR reads the specific arrangement or shape of the lines, the MCU executes the drive algorithm according to the kind of the paper model 200.

As described above, the identification portion 224b contains the identification information corresponding to the kind of the paper model 200, and at least any one of the loudspeaker unit 460, the illumination unit 440, and the operating unit 420 is driven by the predetermined algorithm on the basis of the identification information scanned by the reader unit 490.

As illustrated in FIG. 3, the drive device 400 includes a board 430 on which electronic devices are mounted to drive and control the loudspeaker unit 460, the illumination unit 440, and the operating unit 420, and a body 410 formed in the shape of a case to house the board 430 therein, with the loudspeaker unit 460, the illumination unit 440, and the operating unit 420 being mounted on the outside of the body. The body 410 is formed with a communication hole through which the operating unit 420 comes into surface-contact with the body mobile unit 220b.

Although not shown in the drawings, the board 430 has a communication module which is electrically connected to the operating unit 420, so as to communicate with a smartphone via near field communication. Accordingly, the operating unit 420 can be radio-controlled by the remote control application installed in the smartphone. In addition to the operating unit 420, the electrical configuration provided in the drive device 400 can be controlled by the remote control application.

FIG. 3 shows that the operating unit 420 is rotated, but the present invention is not limited thereto. The operating unit 420 can be operated in any one manner among rotation movement, vertical movement, horizontal movement, tilting movement, and piston movement. It would be noted that the mechanical configuration and structure will be varied depending upon the operating manner, and the detailed description will be omitted herein.

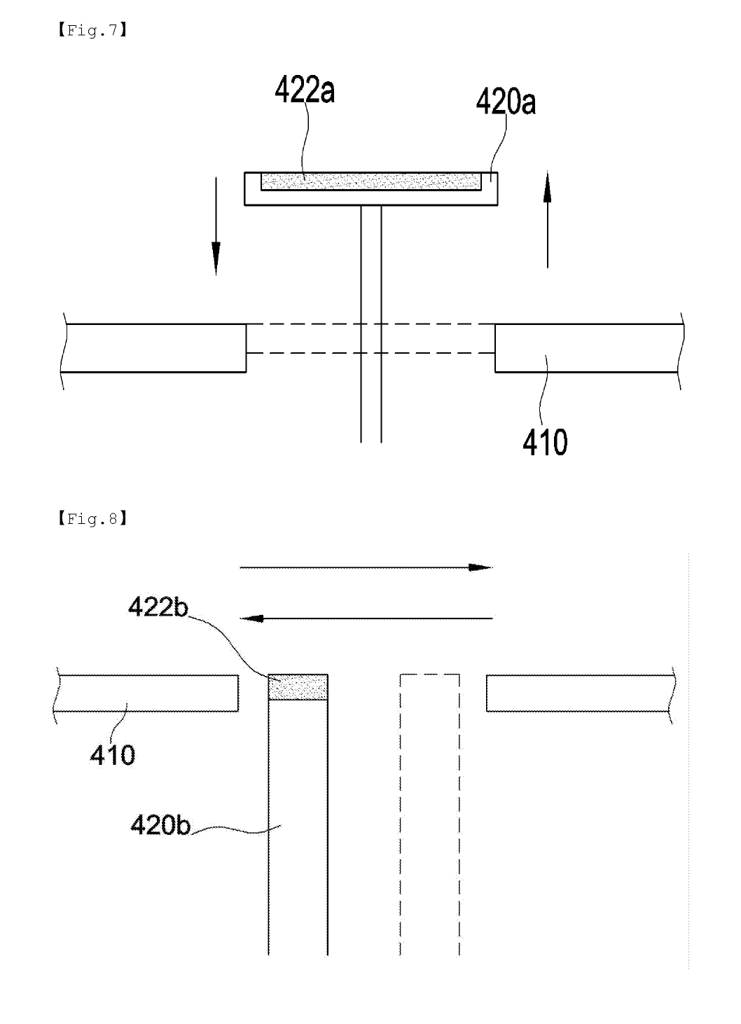

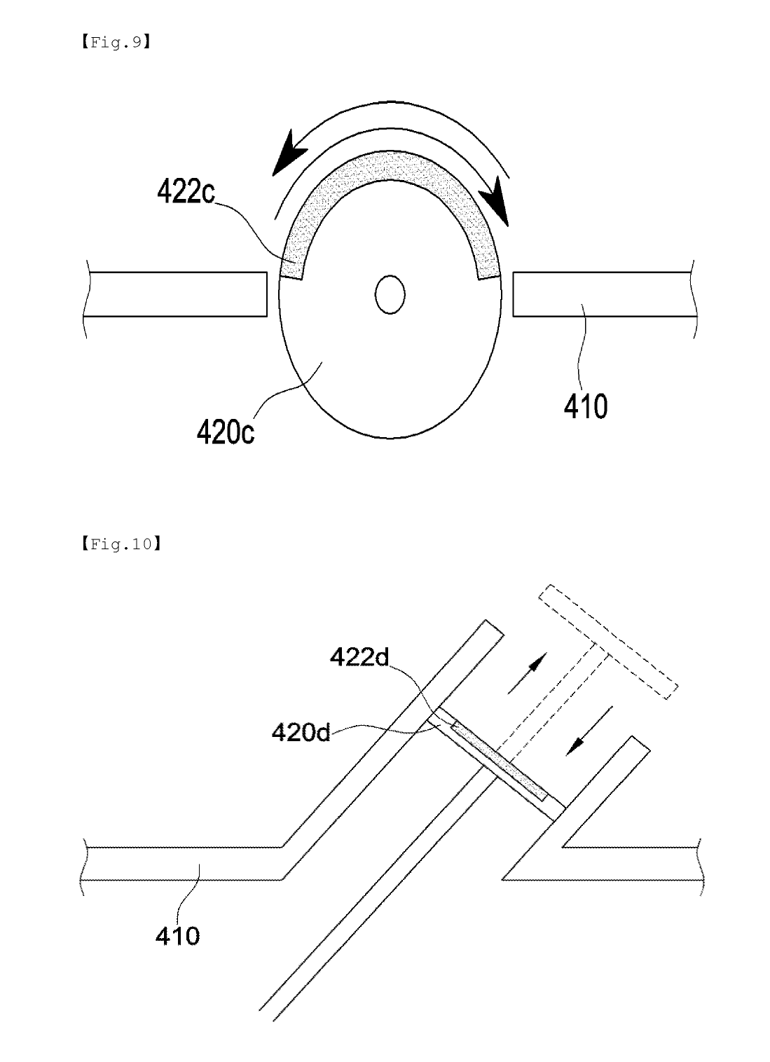

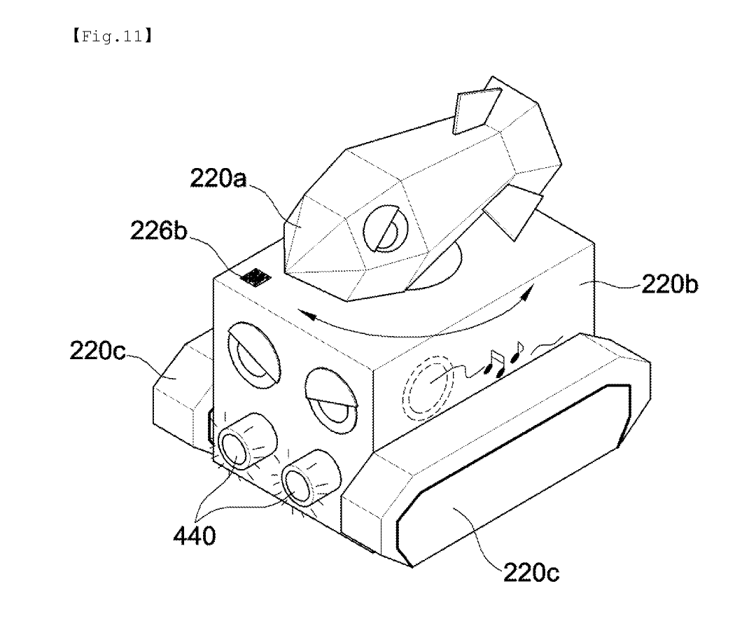

FIG. 7 illustrates schematically the vertical movement of an operating unit 420a, and FIG. 8 illustrates schematically the horizontal movement of an operating unit 420b. FIG. 9 illustrates schematically the tilting movement of an operating unit 420c, and FIG. 10 illustrates schematically the piston movement of an operating unit 420d.

For example, the operating unit 420 configured to perform the rotating movement is provided with a model unit corresponding to the rotation, like a revolving turret for a tank. Therefore, each of the operating units is preferably provided with a model unit corresponding to the operating manner.

In addition, the board 430 has a communication module (not illustrated) which is electrically connected to the loudspeaker unit 460, the illumination unit 440, the operating unit 420, and the reader unit 490, so as to communicate with a smartphone via near field communication. Accordingly, at least one of the loudspeaker unit 460, the illumination unit 440, and the operating unit 420 can be radio-controlled by the remote control application installed in the smartphone. The communication module can be connected to the internet via the near field communication, and can be selected from Ethernet, Wi-Fi, Bluetooth, ZigBee, UWB, wireless USB according to the configuration of the toy and installation circumstance.

As illustrated in FIGS. 4, 7 and 11, any one of the model units forming the paper model 200 may be provided with an identification code 226b of a barcode type. The identification code 226b is scanned by the smartphone, so that a remote control application may be installed in the smartphone.

For example, the identification code 226b may be recorded with information about a website address consisting of numerals or characters, and the smartphone can be connected to the website by recognition of the camera. The remote control application registered in the website is downloaded and installed in the smartphone by selection of the user, and the installed remote control application controls the loudspeaker unit 460, the illumination unit 440, and the operating unit 420 at remote through the cooperation between the smartphone and the communication module of the drive device.

Accordingly, the user can control the drive device 400, which is assembled and connected to the paper model 200, at remote. In particular, as illustrated in FIGS. 11 and 12, as the operating unit 420 rotates, the head model units 220a and 240a adhered to the operating unit by the magnetic force rotate in cooperation with the operating unit 420.

In addition, since model units of various shapes are adhered to the operating unit 420, various mobile toys can be employed even by one drive device 400. Specifically, as illustrated in FIG. 11, the missile-shaped model unit 220a is adhered to and is operated by the operating unit. If the user wants to replace it by other kind, the missile-shaped model unit 220a is detached from the operating unit, and then the turret-shaped model unit 240a is adhered to the operating unit, as illustrated in FIG. 12, thereby easily changing the shape of the toys.

The above-described embodiments of the present invention have the following advantages.

The paper model can be made on the basis of the development figure having various levels of difficulty and various designs, and can be operated in cooperation with the drive device in various manners according to the kinds of the paper models. Therefore, since the paper model is friendly and animatedly realized, the paper model can arouse continuous interest and possessing desire.

Instead of bulk and heavy books or toys, users can directly make a paper model corresponding to education or play on the basis of the development figure, and the paper model can be connected with the education or the play in cooperation with the drive device, thereby developing the creativity.

Since the paper models of various designs can be easily attached to or detached from the operating unit of the drive device by the magnet and the magnetic body, the paper model can be immediately replaced by a paper model of a different design depending upon the situations. Therefore, people of all ages can handle the paper model, and it can continuously arouse user's interest in the mobile toy at education or play.

Finally, since modules having several functions are mounted on the drive device and are operated in various manners in cooperation with the smartphone, the present invention can be extended to products of various kinds.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A mobile toy using paper craft comprising:
a drive device including at least one operating unit which is operated by a power; and
a paper model including a plurality of model units which are made on the basis of a development figure and are assembled and engaged to an outside of the drive device to form a toy, at least one of the mobile units being detachably engaged to the operating unit.

2. The mobile toy using paper craft according to claim 1, wherein the drive device includes a loudspeaker unit to output desired sound, an illumination unit to emit a desired pattern of light, and a reader unit to scan a predetermined object to be identified on one side thereof.

3. The mobile toy using paper craft according to claim 1, wherein one of the model units is provided on one side thereof with an identification portion which is scanned by the reader unit.

4. The mobile toy using paper craft according to claim 1, wherein the operating unit of the drive device is provided with a magnet having a desired magnetic force, and the model unit engaged to the operating unit is provided with a magnetic body which is adhered to the magnet.

5. The mobile toy using paper craft according to claim 1, wherein the reader unit includes a non-contact near field communication reader or a barcode scanning camera, and the identification portion includes an electronic tag or barcode which is scanned by the reader unit.

6. The mobile toy using paper craft according to claim 1, wherein the drive device includes a board on which electronic devices are mounted to drive and control the operating unit, and a body formed in the shape of a case to house the board therein, and formed with a communication hole through which the operating unit comes into surface-contact with the model unit.

7. The mobile toy using paper craft according to claim 6, wherein the board is provided with a communication module which is electrically connected to the operating unit, so as to communicate with a smartphone via near field communication, and the operating unit is controlled by remote control application installed in the smartphone.

8. The mobile toy using paper craft according to claim 7, wherein the operating unit is operated in any one manner among rotation movement, vertical movement, horizontal movement, tilting movement, and piston movement through combination of a plurality of driving members, and the operating unit is controlled by selecting one of the operation manners by the remote control application installed in the smartphone.

9. The mobile toy using paper craft according to claim 6, wherein one of the plurality of model units is a body model unit which is brought into surface-contact with a body of the drive device, and is provided with on an inner surface thereof with an identification portion, and the identification portion is disposed at a position corresponding to the reader unit when the body model unit is engaged to the body, and is scanned by the reader unit.

10. The mobile toy using paper craft according to claim 9, wherein the identification portion contains identification information corresponding to a kind of the paper model, and at least any one of the loudspeaker unit, the illumination unit, and the operating unit is driven by predetermined algorithm according to the identification information scanned by the reader unit.

11. The mobile toy using paper craft according to claim 10, wherein the board is provided with a communication module which is electrically connected to the loudspeaker unit, the illumination unit, the operating unit, and the reader unit, so as to communicate with a smartphone via near field communication, and at least one of the loudspeaker unit, the illumination unit, and the operating unit is controlled by the remote control application installed in the smartphone.
